(19) United States
(12) Patent Application Publication
(10) Pub. No.: US 2026/0326463 A1
(43) Pub. Date: Oct. 22, 2026

(54) INKJET RECORDING APPARATUS

(71) Applicant: KYOCERA Document Solutions Inc., Osaka (JP)

(72) Inventors: Daisuke MIMURA, Osaka (JP); Masakazu UEHARA, Osaka (JP); Hiroaki OHASHI, Osaka (JP); Naozumi OGAWA, Osaka (JP)

(73) Assignee: KYOCERA Document Solutions Inc., Osaka (JP)

(21) Appl. No.: 19/651,253

(22) Filed: Apr. 17, 2026

(30) Foreign Application Priority Data
Apr. 21, 2025 (JP) 2025-069746

(51) Int. Cl. B41J 25/304; B41J 2/165; B41J 13/08

(52) U.S. Cl. CPC B41J 25/304; B41J 2/16535; B41J 13/08; B41P 2235/20

(57) ABSTRACT

A recording portion includes a recording head having a nozzle face with a plurality of nozzles formed in it from which ink is ejected, and a head housing that holds the recording head. A first movement mechanism moves the recording portion such that it can move toward and away from a conveyance unit. The nozzle face and a conveyance face are disposed so as to incline with respect to the plane orthogonal to the movement direction of the recording portion. The recording portion includes a protruding part protruding from the head housing in the ink ejection direction to be located outward beyond the tips of the nozzles. The protruding part makes contact with the conveyance unit such that the nozzle face is disposed at a predetermined interval from the conveyance face.

### INCORPORATION BY REFERENCE

This application is based on and claims the benefit of priority from Japanese Patent Application No. 2025-069746 filed on Apr. 21, 2025, the contents of which are hereby incorporated by reference.

### BACKGROUND

The present disclosure relates to an inkjet recording apparatus.

Conventional inkjet recording apparatuses include a conveyance unit, a recording portion, and a first movement mechanism. The conveyance unit has a conveyance belt that conveys a recording medium. The recording portion includes a recording head having a nozzle face with a plurality of nozzles formed in it from which ink is ejected, and a head housing that holds the recording head. The first movement mechanism moves the recording portion such that it can move toward or away from the conveyance unit. The first movement mechanism changes the distance from the nozzle face to a conveyance face between a middle part and an edge part of the recording medium along the width direction or conveyance direction of the recording medium. This helps suppress degradation of image quality.

Requiring complicated control for the first movement mechanism, those conventional inkjet recording apparatuses inconveniently entail increased manufacturing cost.

An object of the present invention is to provide an inkjet recording apparatus that can suppress degradation of image quality while suppressing an increase in manufacturing costs.

### SUMMARY

To attain the above object, according to one aspect of the present invention, an inkjet recording apparatus includes a conveyance unit, a recording portion, and a first movement mechanism. The conveyance unit includes a conveyance unit for conveying a recording medium. The recording portion includes a recording head having a nozzle face with a plurality of nozzles formed in it from which ink is ejected, and a head housing that holds the recording head. The first movement mechanism moves the recording portion such that it can move toward and away from the conveyance unit. The nozzle face and the conveyance face of the conveyance belt are disposed so as to incline with respect to the plane orthogonal to the movement direction of the recording portion. The recording portion includes a protruding part that protrudes from the head housing in the ink ejection direction to be located outward beyond the tips of the nozzles. The protruding part makes contact with the conveyance unit such that the nozzle face is disposed at a predetermined interval from the conveyance face.

This and other objects of the present disclosure, and the specific benefits obtained according to the present disclosure, will become apparent from the description of embodiments which follows.

### BRIEF DESCRIPTION OF THE DRAWINGS

FIG. 1 is a diagram illustrating an outline of the configuration of a printer according to one embodiment of the present invention.

FIG. 2 is a diagram illustrating an outline of the configuration of the printer according to the embodiment of the present invention.

FIG. 3 is a perspective view around a recording portion in the printer according to the embodiment of the present invention.

FIG. 4 is a perspective view of the recording portion in the printer according to the embodiment of the present invention.

FIG. 5 is a perspective view of the recording portion in the printer according to the embodiment of the present invention.

FIG. 6 is a side view showing part of the recording portion in the printer according to the embodiment of the present invention.

FIG. 7 is a plan view of a head housing of the recording portion in the printer according to the embodiment of the present invention, as seen from an ink ejection face.

FIG. 8 is a side view of a recording head constituting a line head in the recording portion in the printer according to the embodiment of the present invention.

FIG. 9 is a plan view of the recording head in the printer according to the embodiment of the present invention, as seen from the ink ejection face.

FIG. 10 is a perspective view of a maintenance unit in the printer according to the embodiment of the present invention.

FIG. 11 is a diagram illustrating the operation of inserting a positioning convex part into a positioning concave part in the printer according to the embodiment of the present invention.

### DETAILED DESCRIPTION

### 1. Configuration of Inkjet Recording Apparatus

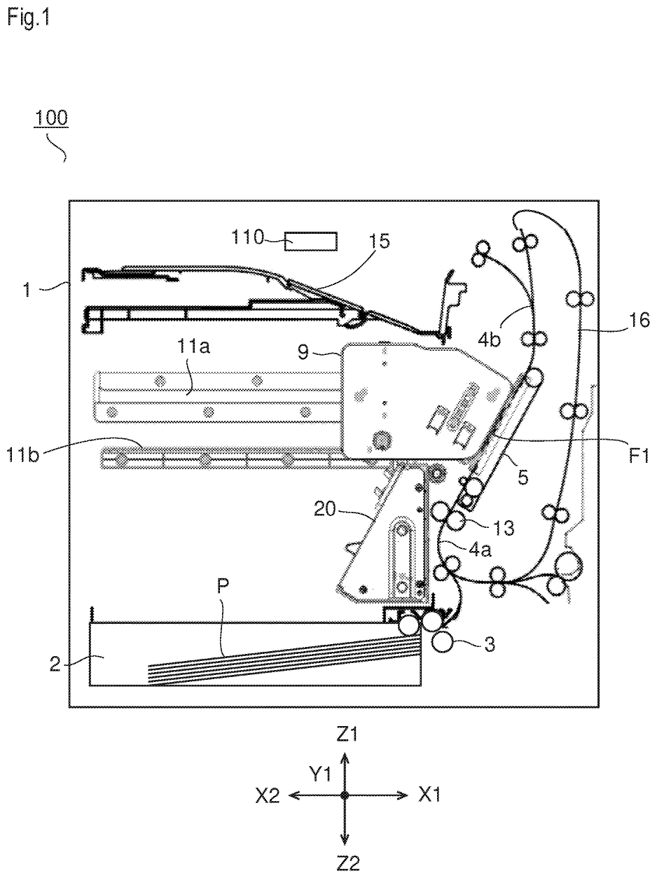

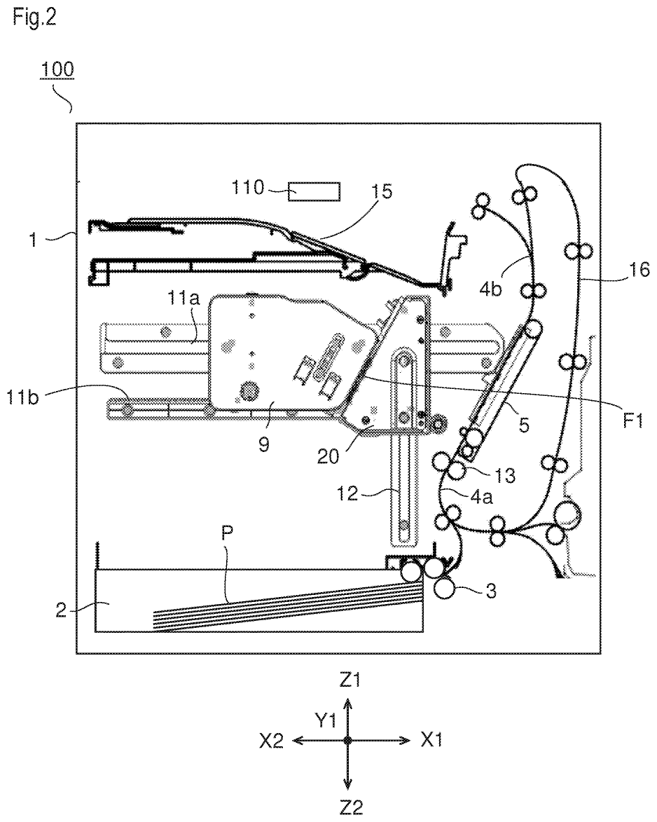

Now, an embodiment of the present invention will be described with reference to the accompanying drawings. FIGS. 1 and 2 are diagrams illustrating an outline of the configuration of a printer 100 as an inkjet recording apparatus according to one embodiment of the present invention. FIG. 1 shows a state where a recording portion 9 is arranged in a printing position, and FIG. 2 shows a state where the recording portion 9 is arranged in a capping position.

The printer 100 includes a sheet feed cassette 2 that is a sheet storage portion. The sheet feed cassette 2 is disposed in a lower part of a printer body 1 inside it. In the sheet feed cassette 2, sheets P as one example of a recording medium are stored.

Downstream of the sheet feed cassette 2 in the sheet conveyance direction, that is, to the upper right of the sheet feed cassette 2 in FIG. 1, a sheet feeding portion 3 is disposed. The sheet feeding portion 3 separates and feeds out one sheet P after another toward the upper right of the sheet feed cassette 2 in FIG. 1.

The printer 100 includes inside it a first sheet conveyance passage 4a. The first sheet conveyance passage 4a is located to the upper right of the sheet feed cassette 2, that is, in its sheet feeding direction. The sheet P fed out of the sheet feed cassette 2 is conveyed vertically upward along a side face of the printer body 1 by the first sheet conveyance passage 4a.

At the downstream end of the first sheet conveyance passage 4a in the sheet conveyance direction, a pair of registration rollers 13 is provided. Closely downstream of the pair of registration rollers 13 in the sheet conveyance direction, a conveyance unit 5 and a recording portion 9 are disposed. The sheet P fed out of the sheet feed cassette 2 passes along the first sheet conveyance passage 4a to reach the pair of registration rollers 13. The pair of registration rollers 13 feeds the sheet S to the conveyance unit 5 while coordinating with ink ejection operation by the recording portion 9.

The sheet P fed out by the pair of registration rollers 13 to the conveyance unit 5 is conveyed to a place opposite the recording portion 9 (in particular, recording heads 17a to 17h, which will be described later). Ink is ejected from the recording portion 9 to the sheet P to record an image on the sheet P. Meanwhile, the ejection of ink by the recording portion 9 is controlled by a control portion 110 in the printer 100.

An ink ejection face F1 of the recording portion 9 and a conveyance belt (not shown) in the conveyance unit 5 are disposed so as to incline at predetermined angles with respect to the horizontal plane as seen from the sheet width direction (Y1-Y2). In addition, the recording portion 9 can be moved along the left-right direction (X1-X2) by a movement mechanism, which will be described later. In printing operation, the recording portion 9 moves rightward X1 to be arranged in a printing position (see FIG. 1). In the printing position, the ink ejection face F1 is disposed opposite the conveyance unit 5 across a predetermined interval, and the sheet P is conveyed along the ink ejection face F1. In response to a control signal from the control portion 110, a recording head 17 ejects ink to the sheet P according to image data received from an external computer to record (print) an image on the sheet P.

The sheet P having the image recorded on it by the recording portion 9 passes along a second sheet conveyance passage 4b, where it is dried and de-curled, and is discharged to a sheet discharge tray 15.

In a right X1 part of the printer body 1, a reverse conveyance passage 16 for duplex recording is disposed. When duplex recording is performed, the sheet P having the image recorded on its one side (first side) is fed to the reverse conveyance passage 16, which branches off the second sheet conveyance passage 4b.

The sheet P fed to the reverse conveyance passage 16 has its conveyance direction switched for recording on its other side (second side). The sheet P is conveyed from an upper to a lower part of the printer body 1 to reach once again, with the second side up, the conveyance unit 5 via the pair of registration rollers 13. In the conveyance unit 5, the sheet P is conveyed to a place opposite the recording portion 9, and an image is recorded on the second side with the ink ejected from the recording portion 9. The sheet P after duplex recording passes through the second sheet conveyance passage 4b and is discharged to the sheet discharge tray 15.

A maintenance unit 20 can be moved along the top-bottom direction (Z1-Z2) by a movement mechanism (second movement mechanism). That is, the movement mechanism (second movement mechanism) moves the maintenance unit 20 such that it can move toward and away from the recording portion 9. In capping operation or wiping operation, the recording portion 9 moves leftward X2 away from the conveyance unit 5. In addition, the maintenance unit 20 is moved upward Z1 such that it approaches the recording portion 9 (see FIG. 2). The configuration of the maintenance unit 20 will be described in detail later.

### 2. Detailed Configuration of Recording Portion

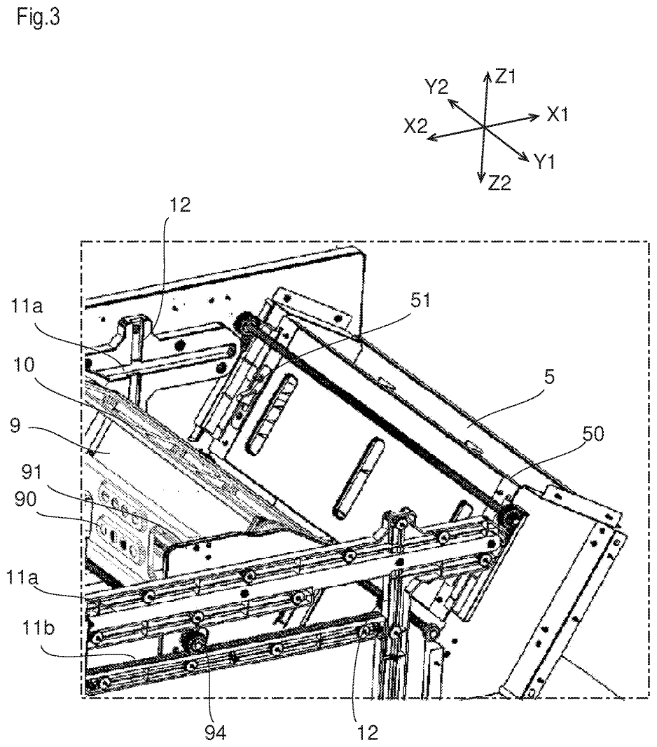

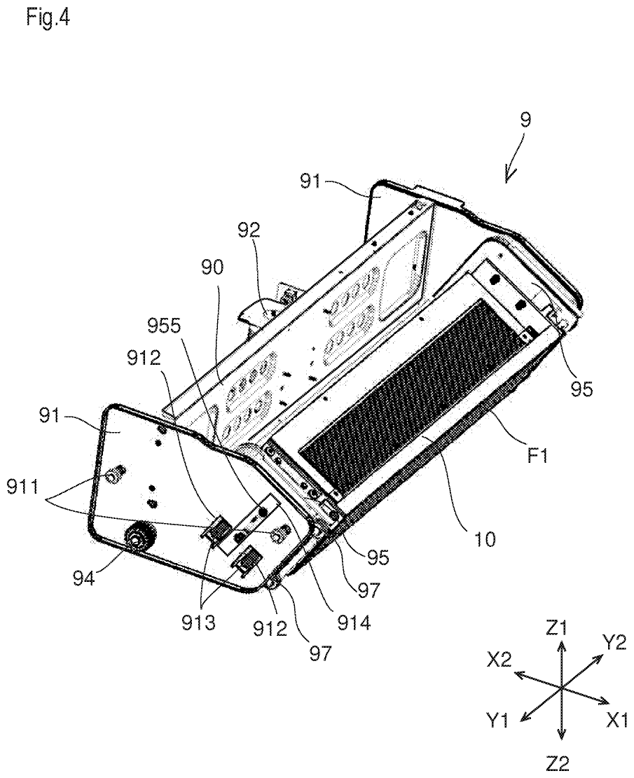

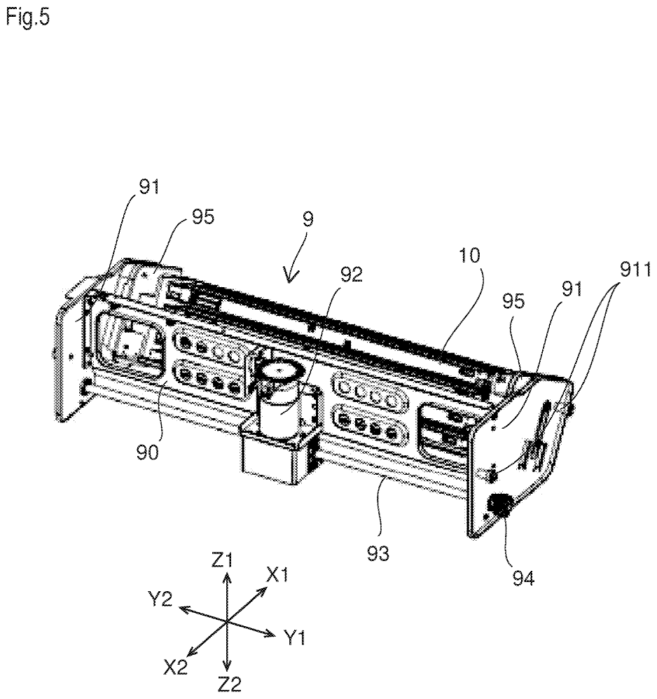

FIG. 3 is a perspective view around the recording portion 9, and FIGS. 4 and 5 are perspective views of the recording portion 9. The recording portion 9 includes a head housing 10, a back frame 90, a pair of side frames 91, a drive motor 92, a shaft 93, gears 94, and bearings 97. The head housing 10 is in a rectangular parallelepiped shape and holds recording heads 17a to 17h, which will be described later.

The back frame 90 is formed in a plate shape and holds, at its right X1, the head housing 10 and, at its left X2, the drive motor 92.

To the opposite sides of the back frame 90 along the sheet width direction (Y1-Y2), the pair of side frames 91 are fixed. The side frames 91 hold the head housing 10 while supporting it from its both sides along the sheet width direction (Y1-Y2). Between the side frame 91 and the head housing 10, an intermediate plate 95 is disposed. The head housing 10 can be moved along two directions with respect to the side frame 91 by a movement mechanism including the intermediate plate 95. This movement mechanism will be described in detail later.

Each of the side frames 91 has two protruding parts 911 that protrude from its outer side face. The protruding parts 911 are arranged in guide grooves 11a. A pair of guide grooves 11a are fixed one at each of the opposite sides of the printer body 1 along the sheet width direction (Y1-Y2) and extend along the left-right direction (X1-X2).

The drive motor 92 has a rotation shaft extending along the top-bottom direction (Z1-Z2) and rotates a drive gear (not shown) fixed to the rotation shaft.

The shaft 93 extends along the sheet width direction (Y1-Y2) and is disposed at the left X2 of the back frame 90. The shaft 93 is connected to the drive gear (not shown) of the drive motor 92 and rotates about a rotation axis extending along the sheet width direction (Y1-Y2). To opposite end parts of the shaft 93, which protrude outward beyond the side frames 91 along the sheet width direction (Y1-Y2), the gears 94 are fixed. The gears 94 are connected to gear racks 11b. A pair of gear racks 11b, disposed below Z2 the guide grooves 11a, are fixed one at each of the opposite sides of the printer body 1 along the sheet width direction (Y1-Y2) and extend along the left-right direction (X1-X2).

As the drive motor 92 rotates forward and backward, the gears 94 rotate forward and backward via the drive gear (not shown) and the shaft 93. This makes the recording portion 9 reciprocate along the gear racks 11b along the left-right direction (X1-X2). In the meantime, the protruding parts 911 slide along the guide grooves 11a to smoothly move the recording portion 9.

In the embodiment, the printer 100 includes the movement mechanism (first movement mechanism) that moves the recording portion 9 such that it can move toward and away from the conveyance unit 5. The movement mechanism includes holding frames (the back frame 90 and the side frames 91) that hold the head housing 10, the drive motor 92, the shaft 93, the gears 94, and the gear racks 11b.

Holding the drive motor 92 with the holding frames (the back frame 90 and the side frames 91) helps reduce the number of gears and thus suppress an increase in the size of the printer 100.

Disposing the gear rack 11b in the printer body (apparatus body) 1 permits a shorter length of the gear rack 11b with respect to the movement distance of the recording portion 9, as compared with in the case where the gear rack 11b is disposed in the recording portion 9. This helps further suppress an increase in the size of the printer 100.

Connecting together the drive motor 92 and the gears 94 via the shaft 93 extending along the direction (Y1-Y2) intersecting with the movement direction (X1-X2) of the recording portion 9 permits the recording portion 9 to be supported on the opposite end parts of the shaft 93. This stabilizes the reciprocation of the recording portion 9.

Moreover, the drive motor 92 is inward of the pair of side frames 91 (holding frames). This helps reduce the size of the recording portion 9 incorporating the drive motor 92 and further suppress an increase in the size of the printer 100.

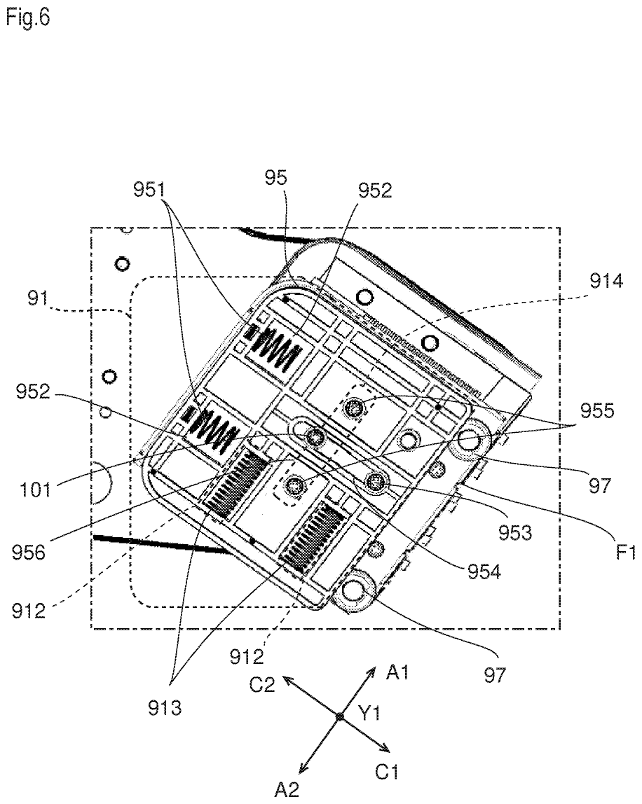

FIG. 6 is an enlarged side view of the intermediate plate 95, where the side frame 91 is indicated by broken lines. The intermediate plate 95 is disposed between the head housing 10 and the side frame 91. The head housing 10 is held on the intermediate plate 95 such that it can move along a first direction (C1-C2) orthogonal to the ink ejection face F1. The head housing 10 is urged in the first direction C1 via a pair of first springs (first elastic member) 951. Note that the first direction C1 is a direction toward the conveyance unit 5 in printing operation and also a direction in which ink is ejected. That is, the recording portion 9 includes the first spring (first elastic member) 951 that urges the head housing 10 in the ink ejection direction C1.

The intermediate plate 95 is held on the side frame 91 so as to be moveable along a second direction (A1-A2). The second direction (A1-A2) is orthogonal to the first direction (C1-C2) and to the sheet width direction (Y1-Y2). The intermediate plate 95 is urged in the second direction A1 via a pair of second springs (second elastic member) 913. Note that the second direction A1 aligns with the conveyance direction of the sheet P conveyed by the conveyance belt (not shown) in the conveyance unit 5. That is, the recording portion 9 includes the second spring (second elastic member) 913 that urges the head housing 10 in the conveyance direction A1 of the sheet P.

Specifically, the intermediate plate 95 has a pair of first spring opening parts 952 and a first guide opening part 954, all penetrating it along the sheet width direction (Y1-Y2). Inside the first spring opening part 952, the first spring 951 is disposed. The first spring 951 has its one end connected to the intermediate plate 95 and has its other end connected to the head housing 10.

The first guide opening part 954 extends along the first direction (C1-C2), and, inside it, a pair of first guide protruding parts 101 are disposed, each protruding outward from one of the opposite side faces of the head housing 10 along the sheet width direction (Y1-Y2). As the first guide protruding part 101 moves along the first guide opening part 954, the head housing 10 moves smoothly along the first direction (C1-C2).

The side frame 91 has a pair of second spring opening parts 912 and a second guide opening part 914, all penetrating it along the sheet width direction (Y1-Y2). Inside the second spring opening part 912, the second spring 913 is disposed. The second spring 913 has its one end connected to the side frame 91 and has its other end connected to the intermediate plate 95.

The second guide opening part 914 extends along the second direction (A1-A2), and, inside it, a pair of second guide protruding parts 955 is disposed, each protruding outward from the intermediate plate 95. As the second guide protruding part 955 moves along the second guide opening part 914, the head housing 10 held on the intermediate plate 95 moves smoothly along the second direction (A1-A2).

The recording portion 9 has the bearings (protruding parts) 97 that protrude from the head housing 10 in the ink ejection direction C1 to be located outward beyond the tips of nozzles 18a. In the embodiment, the bearings (protruding parts) 97 are disposed in a circumferential part of the intermediate plate 95 toward the first direction C1 and are supported so as to be rotatable with respect to the intermediate plate 95. Two bearings 97 are arrayed along the second direction (A1-A2) on each of the intermediate plate 95. In a state where the recording portion 9 is away from the conveyance unit 5 and the maintenance unit 20, the ends of the bearings 97 toward the first direction C1 are located outward beyond the side frame 91 in the first direction C1. The bearings 97 are supported on the intermediate plate 95 so as to be rotatable about the sheet width direction (Y1-Y2).

With the above configuration, when the recording portion 9 approaches the conveyance unit 5, the bearings 97 make contact with the opposite end parts of the conveyance unit 5 along the sheet width direction (Y1-Y2) to stop the movement of the recording portion 9. Thus, in the printing position, the ink ejection face F1 is reliably disposed opposite the conveyance unit 5 across a predetermined interval.

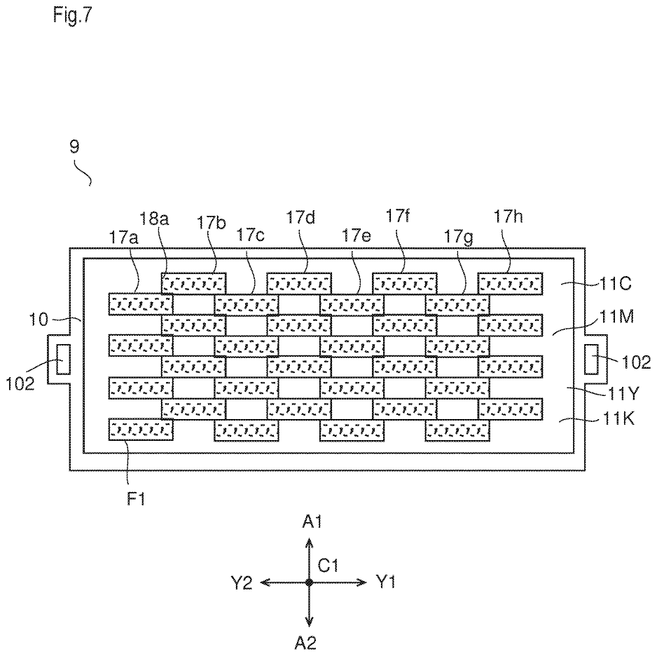

FIG. 7 is a plan view of the head housing 10 as seen from the ink ejection face F1. The head housing 10 holds line heads 11C, 11M, 11Y, and 11K. In printing operation, the line heads 11C to 11K are supported at such positions as to leave a predetermined interval (e.g., 1 mm) from the conveyance face of the conveyance unit 5. The line heads 11C to 11K are formed with a plurality of (here, eight) recording heads 17a to 17h arrayed in a staggered formation along the sheet width direction (Y1-Y2). Note that, since the eight recording heads 17a to 17h for each color have the same shape and the same configuration, in the following description, no distinguishing suffixes (a, b, c) are used.

The head housing 10 has a pair of positioning concave parts 102. The pair of positioning concave parts 102 are disposed, in a circumferential part of the head housing 10 toward the ink ejection face F1, one at each of its opposite sides along the sheet width direction (Y1-Y2). In capping operation, the positioning concave parts 102 have inserted in them positioning convex parts 231 of the maintenance unit 20, which will be described later.

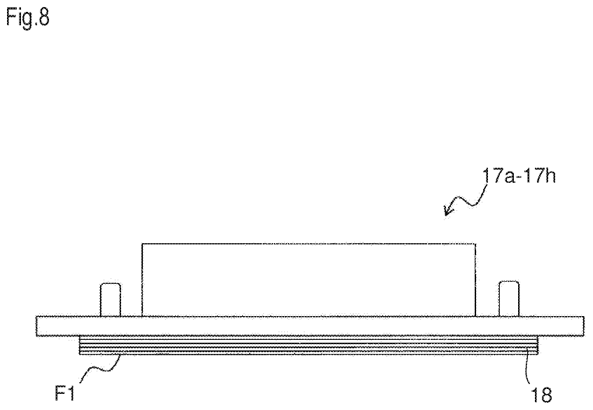

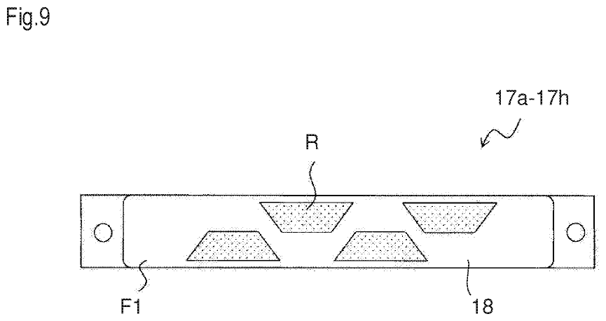

FIG. 8 is a side view of the recording head 17 in the line heads 11C to 11K in the recording portion 9, and FIG. 9 is a plan view of the recording head 17 as seen from the ink ejection face F1.

The ink ejection face F1 of a head portion 18 in the recording head 17 is provided with a plurality (here, four blocks) of nozzle regions R with a number of nozzles 18a (see FIG. 7) arrayed in them. At least the ink ejection face F1 of the head portion 18 is made of, for example, SUS (stainless steel). The ink ejection face F1 is subjected to water repellent treatment by application of a fluorinated or a silicone-based water-repellent.

To the recording heads 17 constituting the line heads 11C to 11K, ink of four colors (cyan, magenta, yellow, and black) stored in ink tanks (not shown), is supplied according to the colors of the line heads 11C to 11K.

In response to a control signal from the controller 110 (see FIG. 1), the recording head 17 ejects ink from the nozzles 18a to the sheet P conveyed while being held under suction on the conveyance face of the conveyance belt in the conveyance unit 5 according to image data received from an external computer. This forms a color image with the ink of four colors, namely cyan, magenta, yellow, and black, overlayed on each other on the sheet P on the conveyance belt.

### 3. Detailed Configuration of Maintenance Unit

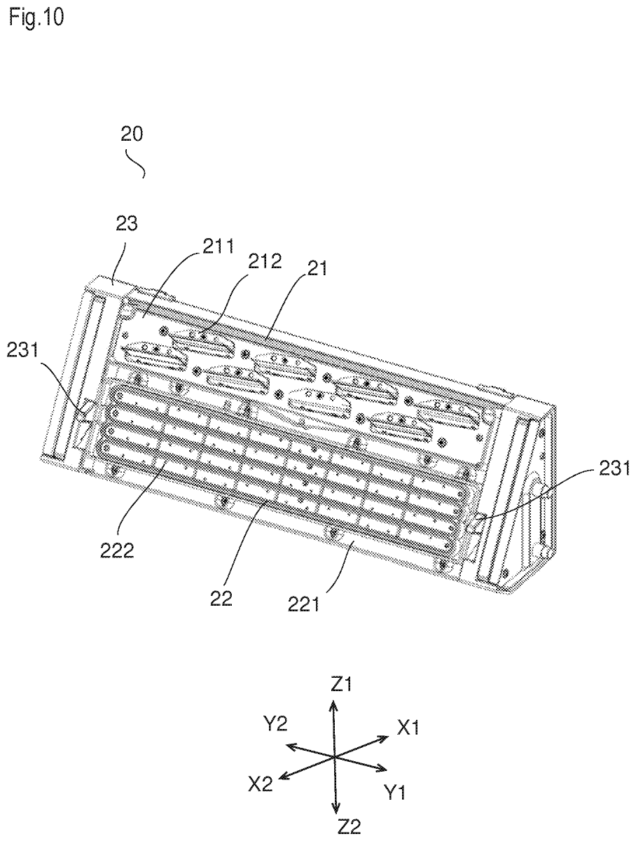

FIG. 10 is a perspective view of the maintenance unit 20. The maintenance unit 20 is configured to be movable up and down in the top-bottom direction (Z1-Z2) along a second rail 12 extending along the top-bottom direction (Z1-Z2) (see FIGS. 1 and 2). The maintenance unit 20 includes a wipe unit 21, a cap unit 22, and a carriage 23.

The carriage 23 has a triangular prismatic shape extending along the sheet width direction (Y1-Y2) and holds on a side face of it the wipe unit 21 and the cap unit 22. The side face of the carriage 23 on which it holds the wipe unit 21 and the cap unit 22 is parallel to the ink ejection face F1 in the recording portion 9 and is disposed so as to incline at a predetermined angle with respect to the horizontal plane. In the side face of the carriage 23, the wipe unit 21 is located above Z1 the cap unit 22.

The carriage 23 has positioning convex parts 231 protruding from its side face at opposite sides of the cap unit 22. The positioning convex parts 231 extend in the first direction (C1-C2) orthogonal to the ink ejection face F1.

The maintenance unit 20 moves to a wiping position in wiping operation to make the wipe unit 21 face the recording head 17. The wipe unit 21 has eight wipers 212: four wipers 212 are arrayed in a row along the sheet width direction (Y1-Y2) and two such rows are disposed along the top-bottom direction (Z1-Z2).

The wipers 212 are disposed substantially at equal intervals along the sheet width direction (Y1-Y2). The wipers 212 in the upper row are disposed at positions corresponding to the recording heads 17b, 17d, 17f, and 17h in each of the line heads 11C to 11K. The wipers 212 in the lower row are disposed at positions corresponding to the recording heads 17a, 17c, 17e, and 17g in each of the line heads 11C to 11K and are fixed a predetermined distance away, along the sheet width direction (Y1-Y2), from the wipers 212 in the upper row.

The wiper 212 is an elastic member (e.g., a member made of rubber such as EPDM) for wiping off the ink pushed out of the nozzles 18a in the recording heads 17a to 17h. The wiper 212 is pressed against a wiping start position outside the nozzle region R (see FIG. 6) with the nozzles 18a open in it, and wipes the ink ejection face F1 including the nozzle region R in a predetermined direction as the maintenance unit 20 moves in the top-bottom direction (Z1-Z2).

The maintenance unit 20 moves to a capping position in capping operation to make the cap unit 22 face the recording head 17. The cap unit 22 has four capping parts 222 arrayed in the top-bottom direction (Z1-Z2), each having a depressed shape and extending along the sheet width direction (Y1-Y2). One capping part 222 collectively caps the recording heads 17a to 17h arrayed in a row along the sheet width direction (Y1-Y2).

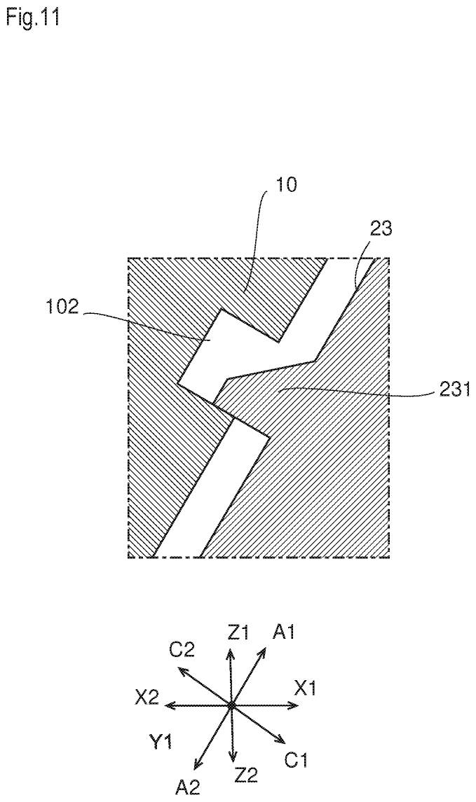

FIG. 11 is a diagram illustrating the operation of inserting the positioning convex part 231 into the positioning concave part 102. In the embodiment, in capping operation, first the maintenance unit 20 is moved to a predetermined capping position, and then the recording portion 9 is moved rightward X1 so that the capping parts 222 cap the ink ejection face F1 of the recording heads 17a to 17h.

In the embodiment, with respect to the capping parts 222 moving rightward X, the ink ejection face F1 of the recording heads 17a to 17h is disposed so as to incline at a predetermined angle with respect to the horizontal plane. In addition, the capping part 222 is disposed with a circumferential part of it inclined at a predetermined angle with respect to the horizontal plane.

The positioning convex part 231 protrudes in the first direction (C1-C2), and the positioning concave part 102 is depressed in the first direction (C1-C2). As the recording portion 9 moves rightward X1, the positioning convex part 231, while sliding across the inner circumferential surface of the positioning concave part 102, is inserted in it. Meanwhile, the head housing 10, specifically the intermediate plate 95, is urged in one direction A1 along the second direction via the pair of second springs (second elastic member) 913 (see FIG. 6).

Thus, while the positioning convex part 231 is inserted in the positioning concave part 102, the displacement of the head housing 10 along the second direction (A1-A2) is corrected against the elastic force of the second spring 913. This reliably permits the capping of the ink ejection face F1 of the recording heads 17a to 17h with the capping parts 222. In this way, it is possible to perform capping with close contact.

When the bearings 97 are in contact with the opposite end parts of the carriage 23 along the sheet conveyance direction (Y1-Y2), the tip part of the positioning convex part 231 is not in contact with the bottom part of the positioning concave part 102. Thus, the recording portion 9 is moved further rightward X1 to bring the tip part of the positioning convex part 231 into contact with the bottom part of the positioning concave part 102. In the meantime, the head housing 10 is pressed in the first direction C1 by the elastic force of the first spring 951. This permits the ink ejection face F1 of the recording heads 17a to 17h to be capped with the capping parts 222 with closer contact.

The present invention is not limited to the embodiment described above, and thus any modifications can be made without departing from the spirit of the present invention. Now, the effects of the present invention will be described more specifically by way of examples. The present invention is not limited in any way by those examples.

The conveyance unit 5 has, on the side face of a housing 50, a positioning convex part 51 disposed outward of the conveyance belt (not shown) along the sheet width direction (Y1-Y2) (see FIG. 3). The positioning convex part 51 protrudes in the first direction (C1-C2) and, in printing operation, is inserted in the positioning concave part 102 in the recording portion 9. This corrects displacement of the recording heads 17a to 17h along the second direction (A1-A2).

The bearing 97 makes contact with the side face of the housing 50 outward beyond the positioning convex part 51 along the sheet width direction (Y1-Y2). Thus, in the printing position, the ink ejection face F1 in the recording portion 9 is reliably disposed opposite the conveyance unit 5 across a predetermined interval. This also corrects displacement of the recording heads 17a to 17h along the second direction (A1-A2).

What is claimed is:

1. An inkjet recording apparatus comprising:
a conveyance unit that includes a conveyance belt for conveying a recording medium;
a recording portion that includes a recording head having a nozzle face with a plurality of nozzles formed therein from which ink is ejected, and a head housing that holds the recording head; and
a first movement mechanism that moves the recording portion such that the recording portion is movable toward and away from the conveyance unit, wherein
the nozzle face and a conveyance face of the conveyance belt are disposed so as to incline with respect to a plane orthogonal to a movement direction of the recording portion,
the recording portion includes a protruding part that protrudes from the head housing in an ink ejection direction to be located outward beyond tips of the nozzles, and
the protruding part makes contact with the conveyance unit such that the nozzle face is disposed at a predetermined interval from the conveyance face.

2. The inkjet recording apparatus according to claim 1 further comprising:
a maintenance unit that includes a plurality of wipers that are slidable with respect to the nozzle face of the recording head; and
a second movement mechanism that moves the maintenance unit such that the maintenance unit is movable toward and away from the recording portion, wherein
a placement surface for the wipers is disposed so as to incline with respect to a plane orthogonal to the movement direction of the recording portion, and
the protruding part makes contact with the maintenance unit such that the nozzle face is disposed at a predetermined interval from the placement surface for the wipers.

3. The inkjet recording apparatus according to claim 1, wherein
the protruding part is curved to be convex in the ink ejection direction.

4. The inkjet recording apparatus according to claim 3, wherein
the protruding part is supported so as to be rotatable with respect to the head housing.

5. The inkjet recording apparatus according to claim 1, wherein
a plurality of the protruding parts are disposed away from each other in a width direction of the recording medium orthogonal to a conveyance direction of the recording medium.

6. The inkjet recording apparatus according to claim 1, wherein
the recording portion includes:
a first elastic member that urges the head housing in the ink ejection direction; and
a second elastic member that urges the head housing in a conveyance direction of the recording medium.
